(19) United States
(12) Patent Application Publication
(10) Pub. No.: US 2024/0405874 A1
(43) Pub. Date: Dec. 5, 2024

(54) DIGITAL SIGNAL PROCESSING CIRCUIT, METHOD, RECEIVER, AND COMMUNICATION SYSTEM

(71) Applicant: NEC Corporation, Minato-ku, Tokyo (JP)

(72) Inventors: Masaki Sato, Tokyo (JP); Manabu Arikawa, Tokyo (JP)

(73) Assignee: NEC Corporation, Minato-ku, Tokyo (JP)

(21) Appl. No.: 18/697,601

(22) PCT Filed: Oct. 29, 2021
(86) PCT No.: PCT/JP2021/040033

§ 371 Date: Apr. 1, 2024

(51) Int. Cl. H04B 10/2513; H04B 10/61

(52) U.S. Cl. CPC H04B 10/2513; H04B 10/6161

(57) ABSTRACT

A chromatic dispersion compensation filter is configured to multiply each of a real component and an imaginary component of each of a first polarization and a second polarization of a polarization-multiplexed optical signal by a filter coefficient that compensates for chromatic dispersion. An adaptive equalizer is configured to multiply input signals and their phase conjugates by a complex impulse response and add the signals multiplied by the complex impulse response. The adaptive equalizer is configured to perform, for each polarization, phase rotation for carrier phase compensation including a frequency offset and rotation reverse to the phase rotation and add, for each polarization, the signals subjected to the phase rotation and the signals subjected to the rotation reverse to the phase rotation.

### TECHNICAL FIELD

The present disclosure relates to digital signal processing circuits, methods, receivers, and communication systems.

### BACKGROUND ART

Multilevel modulation, such as high-order quadrature amplitude modulation (QAM), is being employed to achieve high spectrum utilization efficiency in optical fiber communication. The introduction of coherent reception technology has enabled flexible equalization signal processing on the receiver side through digital signal processing involving, for example, collectively compensating for, on the receiver side, the chromatic dispersion that accumulates in the optical fiber transmission line. However, high-order multilevel modulated signals are generally susceptible to distortion. Therefore, distortion resulting from, for example, the incompleteness of components within transmitter-receivers is to become a new bottleneck in advancing higher multileveling. In particular, to achieve an optical transmission system of 1 T bit per second (bps) or higher, a high symbol rate and a high multilevel modulation scheme are essential, and to ensure performance in such a high-level modulation scheme, high-accuracy equalization processing is necessary.

As related art, Non Patent Literature 1 discloses multilayer strictly linear (SL) and widely linear (WL) filters for compensating for linear distortion including in-transmitter distortion and in-receiver distortion. The multilayer SL and WL filters include an in-receiver distortion compensation filter, a chromatic dispersion compensation filter, a polarization separation filter, a carrier phase compensation filter, and an in-transmitter distortion compensation filter. The multilayer SL and WL filters receive input of a sequence of a total of four real number reception signals of in-phase (I) components and quadrature (Q) components of local oscillator light of each of the two polarizations, the X and Y polarizations.

The in-receiver distortion compensation filter, the chromatic dispersion compensation filter, the carrier phase compensation filter, and the in-transmitter distortion compensation filter compensate for, respectively, in-transmitter distortion, chromatic dispersion, carrier phase noise, and in-transmitter distortion of each of the polarizations. According to Non Patent Literature 1, a 2×1 WL filter disposed for each of the polarizations is used for the in-receiver distortion compensation filter and the in-transmitter distortion compensation filter. For the chromatic dispersion compensation filter and the carrier phase compensation filter, a 1×1 SL filter disposed for each of the polarizations is used.

The polarization separation filter is a filter that performs polarization mode dispersion compensation and polarization separation and handles the two polarizations. According to Non Patent Literature 1, a 2×2 SL filter is used for the polarization separation filter. The coefficients of the in-receiver distortion compensation filter, the polarization separation filter, and the in-transmitter distortion compensation filter are controlled adaptively with the use of the output of the in-transmitter distortion compensation filter, that is, the final-stage filter.

Herein, the 2×1 WL filter is equivalent to a real signal-input real coefficient 2×2 MIMO filter having 2×2-4 real coefficient filters. According to the present disclosure, a complex coefficient MIMO filter receiving input of a complex signal and its complex conjugate and an equivalent real signal-input real coefficient MIMO filter are collectively referred to also as a WL MIMO filter. In this context, a normal complex signal-input complex coefficient MIMO filter is referred to as an SL MIMO filter.

As another related art, Patent Literature 1 discloses a receiver that includes a demodulation digital signal processing unit. The demodulation digital signal processing unit receives input of a real component XI and an imaginary component XQ of the X-polarization of a reception complex signal and a real component YI and an imaginary component YQ of the Y-polarization of the reception complex signal. The demodulation digital signal processing unit convolutes an impulse response that compensates for frequency characteristics of the receiver and a complex impulse response for chromatic dispersion compensation into each of the real component XI, the imaginary component XQ, the real component YI, and the imaginary component YQ.

Furthermore, the digital signal processing unit dynamically compensates, in the adaptive equalizer, for the IQ imbalance or IQ lane-to-lane skew produced in the transmitter or the bias shift in the IQ modulator, in addition to the impairment produced in the optical fiber transmission line and the receiver. The adaptive equalizer is constituted by an 8×2 complex IQ WL multiple-input and multiple-output (MIMO) equalizer. The adaptive equalizer served by the MIMO equalizer receives input of eight signals: a real component XI, an imaginary component XQ, a real component YI, and an imaginary component YQ of a complex signal and their respective phase conjugates. In the output of the adaptive equalizer, a signal subjected to phase rotation for frequency offset compensation and a signal subjected to phase rotation reverse to the phase rotation for the frequency offset compensation are added. The adaptive equalizer described in Patent Literature 1 can compensate for the effect produced in the transmitter-side device (also referred to below as “Tx load”) and the effect produced in the receiver-side device (also referred to below as “Rx load”) on the receiver side at once with the use of the 8×2 complex IQ WL MIMO.

### CITATION LIST

### Patent Literature

Patent Literature 1: Japanese Unexamined Patent Application Publication No. 2020-141294

### Non Patent Literature

Non Patent Literature 1: Manabu Arikawa, and Kazunori Hayashi, “Transmitter and receiver impairment monitoring using adaptive multi-layer linear and widely linear filter coefficients controlled by stochastic gradient descent,” Optics Express Vol. 29, Issue 8, pp. 11548-11561, 2021.

### SUMMARY OF INVENTION

### Technical Problem

In the adaptive equalizer described in Patent Literature 1, a signal subjected to phase rotation for frequency offset compensation and a signal subjected to phase rotation reverse to the phase rotation for the frequency offset compensation are added in the adaptive equalizer. The adaptive equalizer described in Patent Literature 1, however, has shortcomings in that the phase noise of the light source affects the accuracy of equalizing in-transmitter distortion.

In view of the circumstances above, one object of the present disclosure is to provide a digital signal processing circuit, a method, a receiver, and a communication method capable of improving the accuracy of equalizing in-transmitter distortion.

### Solution to Problem

To achieve the object above, the present disclosure provides, as a first aspect, a digital signal processing circuit. The digital signal processing circuit includes: a chromatic dispersion compensation filter configured to multiply each of a real component and an imaginary component of each of a first polarization and a second polarization of a polarization-multiplexed optical signal transmitted from a transmitter and received by a receiver by a filter coefficient that compensates for chromatic dispersion; an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals; and a filter coefficient updating unit configured to update the phase rotation for the carrier phase compensation and the complex impulse response that is multiplied by the adaptive equalizer, by use of an output of the adaptive equalizer.

The present disclosure provides, as a second aspect, a receiver. The receiver includes: a detector configured to coherently receive a polarization-multiplexed optical signal transmitted from a transmitter via a transmission line; and a digital signal processing circuit configured to perform equalization signal processing on the reception signal coherently received. The digital signal processing circuit includes: a chromatic dispersion compensation filter configured to multiply each of a real component and an imaginary component of each of a first polarization and a second polarization of the reception signal by a filter coefficient that compensates for chromatic dispersion; an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals; and a filter coefficient updating unit configured to update the phase rotation for the carrier phase compensation and the complex impulse response that is multiplied by the adaptive equalizer, by use of an output of the adaptive equalizer.

The present disclosure provides, as a third aspect, a communication system. The communication system includes: a transmitter configured to transmit a polarization-multiplexed optical signal via a transmission line; a receiver including a detector configured to coherently receive the polarization-multiplexed optical signal transmitted from the transmitter; and a digital signal processing circuit configured to perform equalization signal processing on the reception signal coherently received. The digital signal processing circuit includes: a chromatic dispersion compensation filter configured to multiply each of a real component and an imaginary component of each of a first polarization and a second polarization of the reception signal by a filter coefficient that compensates for chromatic dispersion; an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals; and a filter coefficient updating unit configured to update the phase rotation for the carrier phase compensation and the complex impulse response that is multiplied by the adaptive equalizer, by use of an output of the adaptive equalizer.

The present disclosure provides, as a fourth aspect, a digital signal processing method. The digital signal processing method includes: in a chromatic dispersion compensation filter, multiplying each of a real component and an imaginary component of each of a first polarization and a second polarization of a polarization-multiplexed optical signal transmitted from a transmitter and received by a receiver by a filter coefficient that compensates for chromatic dispersion; in an adaptive equalizer configured to receive input of signals indicating a real component and an imaginary component of the first polarization output from the chromatic dispersion compensation filter and signals indicating a real component and an imaginary component of the second polarization output from the chromatic dispersion compensation filter, multiplying each of the signals indicating the real component and the imaginary component of the first polarization and the signals indicating the real component and the imaginary component of the second polarization by a complex impulse response, adding the signals each multiplied by the complex impulse response, subjecting the added signals to phase rotation for carrier phase compensation including a frequency offset for each polarization, multiplying each of signals indicating phase conjugates of the real component and the imaginary component of the first polarization and signals indicating phase conjugates of the real component and the imaginary component of the second polarization by a complex impulse response, adding the signals each multiplied by the complex impulse response, subjecting the added signals to rotation reverse to the phase rotation for the carrier phase compensation for each polarization, adding, for each polarization, the signals subjected to the phase rotation for the carrier phase compensation and the signals subjected to the rotation reverse to the phase rotation for the carrier phase compensation, and outputting the added signals; and updating the phase rotation for the carrier phase compensation and the complex impulse response that is multiplied by the adaptive equalizer, by use of an output of the adaptive equalizer.

### Advantageous Effects of Invention

The digital signal processing circuit, the method, the receiver, and the communication method according to the present disclosure can improve the accuracy of equalizing in-transmitter distortion.

### BRIEF DESCRIPTION OF DRAWINGS

FIG. 1 is a block diagram schematically showing a communication system according to the present disclosure;

FIG. 2 is a block diagram showing a schematic configuration of a receiver;

FIG. 3 is a block diagram showing a signal transmission system according to a first example embodiment of the present disclosure;

FIG. 4 is a block diagram showing an example of a basic configuration of a digital signal processing unit;

FIG. 5 is a block diagram showing an example of a more detailed configuration of a digital signal processing unit;

FIG. 6 is a block diagram showing typical digital signal processing for performing Rx load compensation, chromatic dispersion compensation, carrier phase compensation, and Tx load compensation;

FIG. 7 is a block diagram showing an example of a configuration of digital signal processing used for description;

FIG. 8 a signal distribution diagram showing a distribution of signals of the I-channel and the Q-channel observed when neither the Tx load nor the Rx load is compensated for;

FIG. 9 is a signal distribution diagram showing a distribution of signals of the I-channel and the Q-channel observed when equalization equivalent to the adaptive equalization described in Patent Literature 1 is performed;

FIG. 10 is a signal distribution diagram showing a distribution of signals of the I-channel and the Q-channel observed when a digital signal processing unit according to an example embodiment is used;

FIG. 11 is a block diagram showing an example of a configuration of a digital signal processing unit used in a second example embodiment of the present disclosure;

FIG. 12 is a block diagram showing an example of a configuration of an adaptive equalizer that includes a phase compensation filter;

FIG. 13 is a schematic diagram showing an example of a waveform observed after subcarrier combining;

FIG. 14 is a block diagram showing an example of a configuration of a digital signal processing unit used in a third example embodiment of the present disclosure;

FIG. 15 is a block diagram showing part of a configuration of an optical transmitter;

FIG. 16 is a block diagram showing an optical receiver used in a modified example; and

FIG. 17 is a block diagram showing part of a configuration of an optical receiver.

### EXAMPLE EMBODIMENT

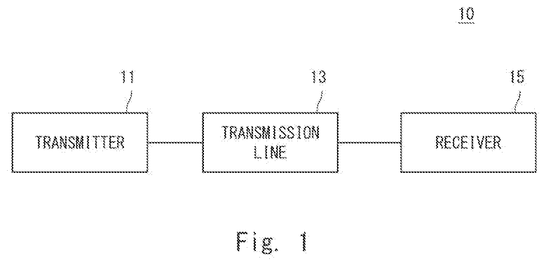

An outline of the present disclosure will be given prior to the description of some example embodiments of the present disclosure. FIG. 1 schematically shows a communication system according to the present disclosure. A communication system 10 includes a transmitter 11 and a receiver 15. The transmitter 11 and the receiver 15 are connected to each other via a transmission line 13. The transmitter 11 transmits a polarization-multiplexed optical signal via the transmission line 13. The receiver 15 receives a polarization-multiplexed optical signal from the transmitter 11 via the transmission line 13.

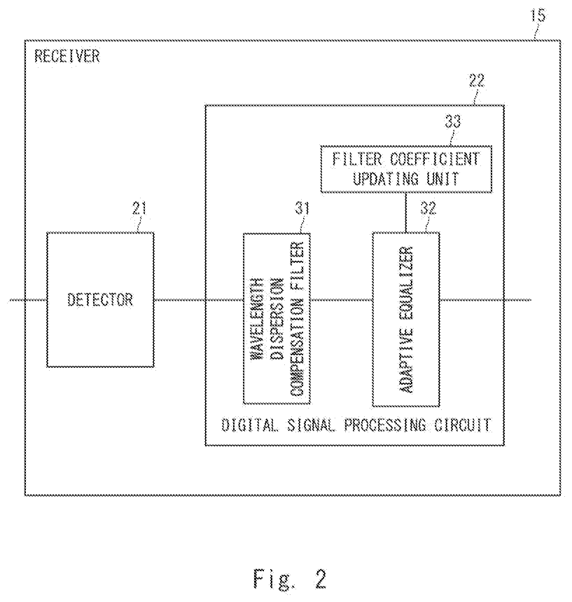

FIG. 2 shows a schematic configuration of the receiver 15. The receiver 15 includes a detector 21 and a digital signal processing circuit 22. The detector 21 coherently receives a polarization-multiplexed optical signal transmitted from a transmitter. The digital signal processing circuit 22 performs equalization signal processing on a reception signal coherently received by the detector 21.

The digital signal processing circuit 22 includes a chromatic dispersion compensation filter 31, an adaptive equalizer 32, and a filter coefficient updating unit 33. The chromatic dispersion compensation filter 31 compensates for chromatic dispersion in a reception signal, that is, a polarization-multiplexed signal. The adaptive equalizer 32 is disposed after the chromatic dispersion compensation filter 31. The adaptive equalizer 32 compensates for distortion in a reception signal. The filter coefficient updating unit 33 updates the coefficient of a filter included in the adaptive equalizer 32 with the use of an output of the adaptive equalizer 32.

The adaptive equalizer 32 receives input of a signal indicating a real component and an imaginary component of a first polarization output from the chromatic dispersion compensation filter 31 and a signal indicating a real component and an imaginary component of a second polarization output from the chromatic dispersion compensation filter 31. The adaptive equalizer 32 multiplies each of the input signals by a complex impulse response, adds the signals multiplied by the complex impulse response, and, for each of the polarizations, subjects the signals added to phase rotation for carrier phase compensation including a frequency offset. Furthermore, the adaptive equalizer 32 multiplies signals each indicating a phase conjugate of the input signal by a complex impulse response and adds the phase conjugate signals multiplied by the complex impulse response. The adaptive equalizer 32, for each of the polarizations, subjects the phase conjugate signals added to rotation reverse to the phase rotation for carrier phase compensation including the frequency offset. The adaptive equalizer 32 adds, for each of the polarizations, the signals subjected to the phase rotation for carrier phase compensation and the signals subjected to the rotation reverse to the phase rotation for carrier phase compensation, and outputs the added signals.

According to the present disclosure, the adaptive equalizer 32 subjects a signal obtained by adding input signals multiplied by a complex impulse response to phase rotation for carrier phase compensation including a frequency offset. Furthermore, the adaptive equalizer 32 subjects a signal obtained by adding phase conjugate signals multiplied by a complex impulse response to rotation reverse to the phase rotation for carrier phase compensation including the frequency offset. According to the present disclosure, phase rotation for carrier phase compensation including a frequency offset and its reverse rotation are performed in the adaptive equalizer 32. Therefore, the scale of influence that phase noise in the light source has on the accuracy of equalizing in-transmitter distortion can be reduced in the adaptive equalizer 32, and high-accuracy equalization of in-transmitter distortion can be achieved.

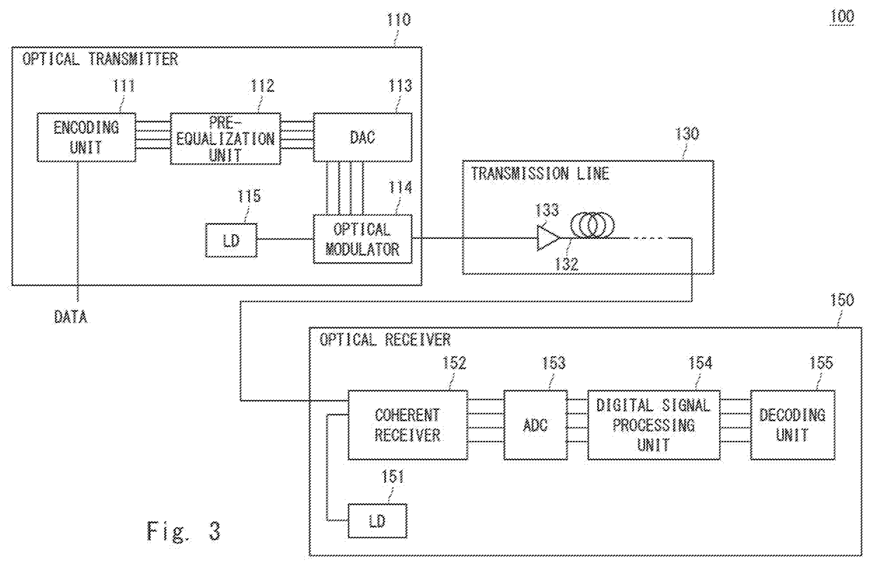

Example embodiments of the present disclosure will be described below in detail. FIG. 3 shows a signal transmission system according to a first example embodiment of the present disclosure. According to the present example embodiment, the signal transmission system is assumed to be an optical fiber communication system employing a polarization-multiplexing QAM scheme and performing coherent reception. An optical fiber communication system 100 includes an optical transmitter 110, a transmission line 130, and an optical receiver 150. The optical fiber communication system 100 constitutes, for example, a submarine fiber-optic cable system. The optical fiber communication system 100 corresponds to the communication system 10 shown in FIG. 1. The optical transmitter 110 corresponds to the transmitter 11 shown in FIG. 1. The transmission line 130 corresponds to the transmission line 13 shown in FIG. 1. The optical receiver 150 corresponds to the receiver 15 shown in FIG. 1.

The optical transmitter 110 converts a plurality of pieces of transmission data into a polarization-multiplexed optical signal. The optical transmitter 110 includes an encoding unit 111, a pre-equalization unit 112, a digital-analog converter (DAC) 113, an optical modulator 114, and a laser diode (LD) 115. The encoding unit 111 encodes data. The encoding unit 111 outputs, for example, a four-sequence signal of the in-phase (I) components and quadrature (Q) components of each of the X-polarization (first polarization) and the Y-polarization (second polarization).

The pre-equalization unit 112 performs, on the encoded four-sequence signal, pre-equalization of compensating in advance for distortion or the like of a device in the optical transmitter. The DAC 113 converts the pre-equalized four-sequence signal to respective analog electrical signals.

The LD 115 outputs continuous-wave (CW) light. The optical modulator 114 modulates the CW light output from the LD 115 in accordance with the four-sequence signal output from the DAC 113, and generates a polarization-multiplexed optical signal. The optical modulator 114 generates, for example, a polarization-multiplexed QAM signal. The optical modulator 114 sends out the polarization-multiplexed optical signal to the transmission line 130.

The transmission line 130 transmits the polarization-multiplexed optical signal output from the optical transmitter 110 to the optical receiver 150. The transmission line 130 includes an optical fiber 132 and an optical amplifier 133. The optical fiber 132 guides the optical signal transmitted from the optical transmitter 110. The optical amplifier 133 amplifies the optical signal and compensates for the propagation loss in the optical fiber 132. The optical amplifier 133 is configured, for example, as an erbium-doped fiber amplifier (EDFA). The transmission line 130 may include a plurality of optical amplifiers 133.

The optical receiver 150 includes an LD 151, a coherent receiver 152, an analog-digital converter (ADC) 153, a digital signal processing unit 154, and a decoding unit 155. In the optical receiver 150, circuits such as the digital signal processing unit 154 and the decoding unit (decoder) 155 may be constituted by a device such as a digital signal processor (DSP).

The LD 151 outputs CW light that serves as local oscillator light. The coherent receiver 152 is configured as a coherent receiver of a polarization diversity type. The coherent receiver 152 performs coherent detection of an optical signal transmitted through the optical fiber 132, with the use of the CW light output from the LD 151. The coherent receiver 152 outputs a four-sequence reception signal (electrical signal) corresponding to the I components and the Q components of the X-polarization and the Y-polarization that have been coherently detected. The coherent receiver 152 corresponds to the detector 21 shown in FIG. 2.

The ADC 153 samples the reception signal output from the coherent receiver 152 and converts the reception signal to a signal in a digital range. The digital signal processing unit 154 performs digital signal processing on the four-sequence reception signal sampled by the ADC 153, and demodulates the reception signal. The digital signal processing unit 154 may include one or more processors and one or more memories. At least part of the functions of the digital signal processing unit 154 may be realized as a processor operates in accordance with a program read out from a memory. The digital signal processing unit 154 corresponds to the digital signal processing circuit 22 shown in FIG. 2. The decoding unit 155 performs decoding of the demodulated signal and restores the transmitted data.

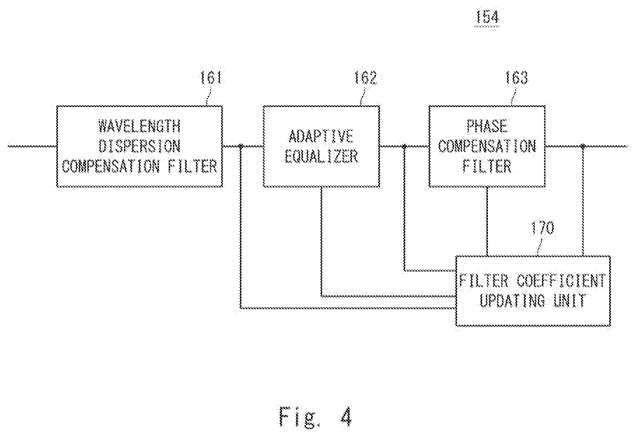

FIG. 4 shows an example of a basic configuration of the digital signal processing unit 154 that performs a digital signal processing method. The digital signal processing unit 154 includes a chromatic dispersion compensation filter 161, an adaptive equalizer 162, a phase compensation filter 163, and a filter coefficient updating unit 170. Although FIG. 4 depicts the phase compensation filter 163 as a block independent from the adaptive equalizer 162, the phase compensation filter 163 is embedded in the adaptive equalizer 162.

In the digital signal processing unit 154, the chromatic dispersion compensation filter 161, the adaptive equalizer 162, and the phase compensation filter 163 are connected in series to an input signal. The digital signal processing unit 154 may include, for example, one or more filters that are disposed before the chromatic dispersion compensation filter 161 and that compensate for distortion in an input signal. The chromatic dispersion compensation filter 161 corresponds to the chromatic dispersion compensation filter 31 shown in FIG. 2. The adaptive equalizer 162 and the phase compensation filter 163 correspond to the adaptive equalizer 32 shown in FIG. 2.

The filter coefficient updating unit 170 monitors the input of the adaptive equalizer 162 and the output of the phase compensation filter 163. The filter coefficient updating unit 170 also monitors the output of the adaptive equalizer 162, that is, the input of the phase compensation filter 163. With the use of the output of the phase compensation filter 163, the filter coefficient updating unit 170 updates the filter coefficient of the adaptive equalizer 162 and the filter coefficient of the phase compensation filter 163. The filter coefficient updating unit 170 adaptively controls the coefficients of the adaptive equalizer 162 and the phase compensation filter 163 through error backpropagation based, for example, on a predetermined loss function. The loss function is calculated based on the difference between a desired state and an output signal of the phase compensation filter 163, the final-stage filter. The filter coefficient updating unit 170 corresponds to the filter coefficient updating unit 33 shown in FIG. 2.

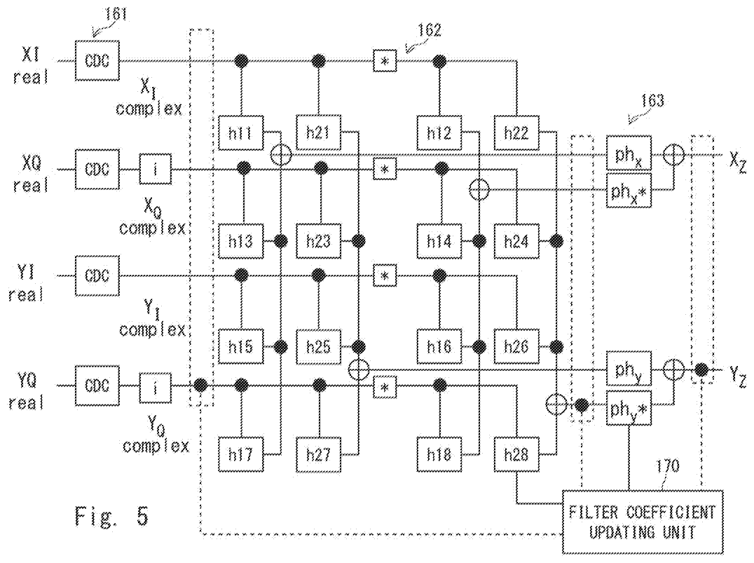

FIG. 5 shows an example of a more detailed configuration of the digital signal processing unit 154. In this example, the adaptive equalizer 162 is configured as a complex WL MIMO filter. The chromatic dispersion compensation (CDC) filter 161 receives input of the IQ components of the X-polarization (XI and XQ) and the IQ components of the Y-polarization (YI and YQ). The chromatic dispersion compensation filter 161 multiplies the I components (real components) XI and YI of, respectively, the X-polarization and the Y-polarization and the Q components (imaginary components) XQ and YQ of, respectively, the X-polarization and the Y-polarization by a filter coefficient that compensates for the chromatic dispersion. The chromatic dispersion compensation filter 161 outputs complex signals X_{I}, X_{Q}, Y_{I}, and Y_{Q} having the chromatic dispersion compensated for.

The adaptive equalizer 162 includes a total of 16 complex coefficient filters constituting an 8×2 complex WL equalizer (also referred to below as 8×2 WL MIMO filter) and the phase compensation filter 163. The 8×2 WL MIMO filter receives input of the real component X_{I} and the imaginary component X_{Q} of the X-polarization output from the chromatic dispersion compensation filter 161 and the real component Y_{I} and the imaginary component Y_{Q} of the Y-polarization output from the chromatic dispersion compensation filter 161. The imaginary components X_{Q} and Y_{Q} of the respective polarizations are each multiplied by i representing an imaginary unit. In the 8×2 WL MIMO filter, each complex coefficient filter multiplies an input signal and a phase conjugate of the input signal by a complex impulse response. In the description below, a phase conjugate may be expressed by “*.” X_{I}, X_{Q}, Y_{I}, and Y_{Q} multiplied by the complex impulse response are added in an adder and output to the phase compensation filter 163. Meanwhile, the phase conjugates of X_{I}, X_{Q}, Y_{I}, and Y_{Q} are added in an adder and output to the phase compensation filter 163.

The phase compensation filter 163 includes filters (phₓ and ph_{y}) that are disposed for the respective polarizations and that perform phase rotation for carrier phase compensation including a frequency offset, and filters (phₓ* and ph_{y}*) that are disposed for the respective polarizations and that perform rotation reverse to the phase rotation. The phase compensation filter 163 performs, for each of the polarizations, phase rotation for carrier phase compensation on the sum of X_{I}, X_{Q}, Y_{I}, and Y_{Q} multiplied by the complex impulse response. Meanwhile, the phase compensation filter 163 performs, for each of the polarizations, phase rotation for carrier phase compensation on the sum of the phase conjugates of X_{I}, X_{Q}, Y_{I}, and Y_{Q} multiplied by the complex impulse response.

The adaptive equalizer 162 adds, for each of the polarizations, the signals subjected to the phase rotation for carrier phase compensation and the signals subjected to the rotation reverse to the phase rotation for carrier phase compensation. The adaptive equalizer 162 outputs, as an output signal X_{Z} of the X-polarization, a signal subjected to phase rotation of phₓ and a signal subjected to phase rotation of phₓ*. Meanwhile, the adaptive equalizer 162 outputs, as an output signal Y_{Z} of the Y-polarization, a signal subjected to phase rotation of ph_{y} and a signal subjected to phase rotation of ph_{y}*.

The filter coefficient updating unit 170 updates the coefficient (complex impulse response) of each complex coefficient filter of the adaptive equalizer 162 so as to minimize the loss function described above. The filter coefficient updating unit 170 updates the coefficient of each complex coefficient filter so as to minimize the loss function calculated based on the output of the phase compensation filter 163 through, for example, stochastic gradient descent. The filter coefficient updating unit 170 calculates the coefficient of the phase compensation filter 163, that is, the amount of phase rotation in the phase compensation filter 163 based on the output of the phase compensation filter 163. The phase compensation amount can be calculated with the use of a typical Mth-power method or a digital phase-locked loop (PLL) using tentative determination. According to the present example embodiment, carrier phase noise including a frequency offset is compensated for in the phase compensation filter 163. The coefficient of the phase compensation filter 163 can be calculated, for example, with the use of a second order PLL having two time constants.

In the following description, in-transmitter distortion (Tx load), in-receiver distortion (Rx load), a frequency offset, and phase noise of a light source can be compensated for in the adaptive equalizer 162 including the phase compensation filter 163. The 8×2 complex WL equalizer used for the adaptive equalizer 162 can be regarded as an equalizer in which a 4×1 complex WL equalizer is expanded for polarization-multiplexing. Therefore, a 4×1 complex WL equalizer is used below in the description of distortion being compensated for.

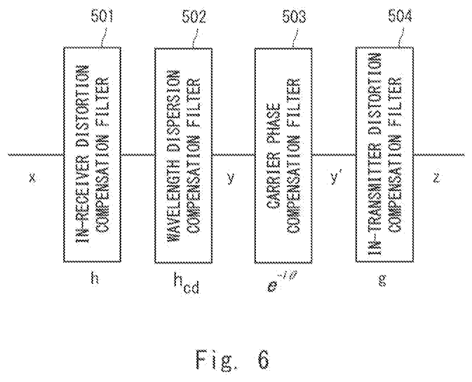

FIG. 6 shows typical digital signal processing for performing Rx load compensation, chromatic dispersion compensation, carrier phase compensation, and Tx load compensation. In this example, digital signal processing includes an in-receiver distortion compensation filter 501, a chromatic dispersion compensation filter 502, a carrier phase compensation filter 503, and an in-transmitter distortion compensation filter 504. The in-receiver distortion compensation filter 501 receives input of a reception signal (digital signal) that is not polarization-multiplexed.

The in-receiver distortion compensation filter 501 is a filter that compensates for the Rx load. The chromatic dispersion compensation filter 502 is a filter that compensates for chromatic dispersion. The carrier phase compensation filter 503 is a filter that compensates for phase noise of the light source. The in-transmitter distortion compensation filter 504 is a filter that compensates for the Tx load. A 2×1 WL filter is used for each of the in-receiver distortion compensation filter 501 and the in-transmitter distortion compensation filter 504.

An input signal of the in-receiver distortion compensation filter 501 is denoted by x, and the filter coefficient of the in-receiver distortion compensation filter 501 is denoted by h. Meanwhile, the coefficient of the chromatic dispersion compensation filter 502 is denoted by h_{cd}, and an output signal of the chromatic dispersion compensation filter 502 is denoted by y. In this case, y is expressed by the following equation using x.

$$y = {h}_{cd} ( hx + {h}_{*} {x}^{*} )$$

When the coefficient of the carrier phase compensation filter 503 is denoted by e^{-iθ}, an output signal y′ of the carrier phase compensation filter 503 is expressed by the following equation.

$${y}^{′} = {ye}^{- i θ}$$

When the filter coefficient of the in-transmitter distortion compensation filter 504 is denoted by g and an output signal of the in-transmitter distortion compensation filter 504 is denoted by z, z is expressed by the following equation.

$$z = {gy}^{′} + {g}_{*} {y}^{′ *} = {gye}^{- i θ} + {g}_{*} {y}^{*} {e}^{i θ} = {ge}^{- i θ} {h}_{cd} ( hx + {h}_{*} {x}^{*} ) + {g}_{*} {e}^{i θ} {h}_{cd}^{*} ( {h}^{*} {x}^{*} + {h}_{*}^{*} x ) = {h}_{cd} {ghe}^{- i θ} x + {h}_{cd} {gh}_{*} {e}^{- i θ} {x}^{*} + {h}_{cd}^{*} {g}_{*} {h}^{*} {e}^{i θ} {x}^{*} + {h}_{cd}^{*} {g}_{*} {h}_{*}^{*} {e}^{i θ} x = {h}_{cd} {f}_{1} {xe}^{- i θ} + {h}_{cd} {f}_{2} {x}^{*} {e}^{- i θ} + {h}_{cd}^{*} {f}_{3} {x}^{*} {e}^{i θ} + {h}_{cd}^{*} {f}_{4} {xe}^{i θ} \qquad ( 1 )$$

When z expressed by the equation (1) above is transformed for each of I and Q, an output signal of the in-transmitter distortion compensation filter 504 can be transformed as in the following.

$$( 2 )$$

$$\text{?} + {iz}_{Q} = ( \text{?} + {ih}_{cdQ} ) ( \text{?} + i \text{?} ) ( \text{?} + {ix}_{Q} ) \text{?} + ( \text{?} + {ih}_{cdQ} ) ( \text{?} + {if}_{2 Q} ) ( \text{?} - {ix}_{Q} ) \text{?} + ( \text{?} - {ih}_{cdQ} ) ( \text{?} + {if}_{3 Q} ) ( \text{?} - {ix}_{Q} ) {e}^{i θ} + ( \text{?} - {ih}_{cdQ} ) ( \text{?} + {if}_{4 Q} ) ( \text{?} + {ix}_{Q} ) {e}^{i θ} = [ \text{} ( \text{?} ( \text{?} + \text{?} ) - {h}_{cdQ} ( \text{?} + {f}_{2 Q} ) ) + i ( \text{?} ( {f}_{1 Q} + {f}_{2 Q} ) + {h}_{cdQ} ( \text{?} + \text{?} ) ) ] \text{?} + [ ( \text{?} ( - {f}_{1 Q} + {f}_{2 Q} ) + {h}_{cdQ} ( \text{?} + \text{?} ) ) + \text{?} ( \text{?} ( \text{?} - \text{?} ) + {h}_{cdQ} ( - {f}_{1 Q} + {f}_{2 Q} ) ) ] {x}_{Q} \text{?} + [ ( \text{?} ( \text{?} + \text{?} ) + {h}_{cdQ} ( {f}_{3 Q} + {f}_{4 Q} ) ) + i ( \text{?} ( {f}_{3 Q} + {f}_{4 Q} ) + {h}_{cdQ} ( - \text{?} - \text{?} ) ] \text{?} {e}^{i θ} + [ ( \text{?} ( {f}_{3 Q} - {f}_{4 Q} ) + {h}_{cdQ} ( - \text{?} + \text{?} ) ) + i ( \text{?} ( - \text{?} + \text{?} ) + {h}_{cdQ} ( - {f}_{3 Q} + {f}_{4 Q} ) ) ] {x}_{Q} {e}^{i θ} = [ ( \text{?} - {h}_{cdQ} {m}_{2} ) + i ( \text{?} {m}_{3} {h}_{cdQ} {m}_{4} ) ] \text{?} {e}^{- i θ} + [ ( \text{?} {m}_{5} + {h}_{cdQ} {m}_{6} ) + i ( \text{?} {m}_{7} + {h}_{cdQ} {m}_{8} ) ] {x}_{Q} {e}^{- i θ} + [ ( \text{?} {m}_{9} + {h}_{cdQ} {m}_{10} ) + i ( \text{?} {m}_{11} + {h}_{cdQ} {m}_{12} ) ] \text{?} {e}^{i θ} + [ ( \text{?} {m}_{13} + {h}_{cdQ} {m}_{14} ) + i ( \text{?} {m}_{15} + {h}_{cdQ} {m}_{16} ) ] {x}_{Q} {e}^{i θ}$$

$$\text{?} \text{indicates text missing or illegible when filed}$$

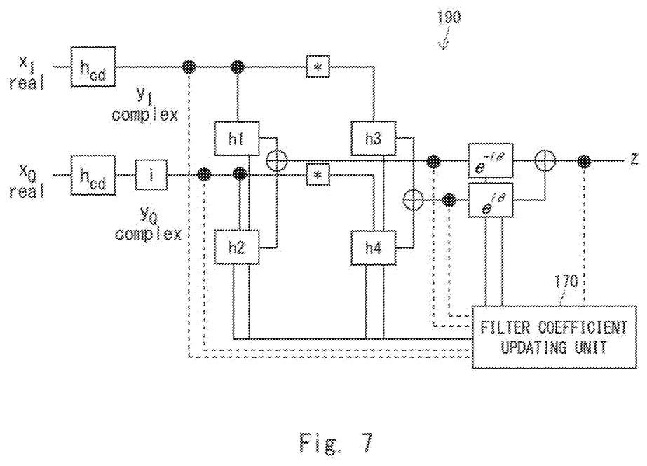

FIG. 7 shows an example of a configuration of digital signal processing used for the description. In FIG. 7, a 4×1 WL equalizer (4×1 complex WL MIMO filter) 190 is used in the digital signal processing. The 4×1 WL equalizer includes two complex conjugate converting units and four complex coefficient filters. The 8×2 complex WL equalizer included in the adaptive equalizer 162 has a configuration in which the 4×1 WL equalizer 190 is expanded for polarization-multiplexing.

The 4×1 WL equalizer 190 receives input of signals individually subjected to chromatic dispersion compensation for I and Q, respectively. An input signal of the chromatic dispersion compensation filter is denoted by x, and the filter coefficient of the chromatic dispersion compensation filter is denoted by h_{cd}. Meanwhile, an input signal of the 4×1 WL equalizer 190 is denoted by y, and the phase rotation in the phase compensation filter is denoted by e^{-iθ}. In this case, the output signal z of the 4×1 WL equalizer 190 is expressed by the following equation.

$$z = {h}_{1} ( \text{?} ) {e}^{- i θ} + {h}_{2} ( {iy}_{Q} ) {e}^{- i θ} + {h}_{3} ( \text{?} ) {e}^{i θ} + {h}_{4} ( {( {iy}_{Q} )}^{*} ) {e}^{i θ}$$

$$\text{?} = {h}_{cd} \text{?} = ( \text{?} + {ih}_{cdQ} ) \text{?}$$

$${y}_{Q} = {h}_{cd} {x}_{Q} = ( \text{?} + {ih}_{cdQ} ) {x}_{Q}$$

$$\text{?} \text{indicates text missing or illegible when filed}$$

When z expressed by the equation above is transformed for each of I and Q, an output signal of the 4×1 WL equalizer 190 can be transformed as in the following.

$$\text{?} + {iz}_{Q} = ( \text{?} + {ih}_{1 Q} ) ( ( \text{?} + {ih}_{cdQ} ) \text{?} {e}^{- i θ} + ( \text{?} + {ih}_{2 Q} ) ( i ( \text{?} + {ih}_{cdQ} ) {x}_{Q} ) {e}^{- i θ} + ( \text{?} + {ih}_{3 Q} ) ( ( \text{?} + {ih}_{cdQ} ) \text{?} ) {e}^{i θ} + ( \text{?} + {ih}_{4 Q} ) ( {( i ( \text{?} + {ih}_{cdQ} ) {x}_{Q} )}^{*} ) {e}^{i θ} = [ ( \text{?} - {h}_{cdQ} {h}_{1 Q} ) + i ( {h}_{cdQ} \text{?} + \text{?} {h}_{1 Q} ) ] \text{} \text{?} \text{} {e}^{- i θ} + [ \text{} ( - {h}_{cdQ} \text{?} - \text{?} {h}_{2 Q} ) + i ( \text{?} - {h}_{cdQ} {h}_{2 Q} ) ] {x}_{Q} {e}^{- i θ} + [ ( \text{?} + {h}_{cdQ} {h}_{3 Q} ) + i ( {h}_{cdQ} \text{?} + \text{?} {h}_{3 Q} ) ] \text{?} + [ ( - {h}_{cdQ} \text{?} + \text{?} {h}_{4 Q} ) + i ( - \text{?} - {h}_{cdQ} {h}_{4 Q} ) ] {x}_{Q} {e}^{i θ}$$

$$\text{?} \text{indicates text missing or illegible when filed}$$

The equations 2 and 3 above are compared with respect to from the first term to the fourth term on the right-hand side. From the relational expression below

$$( \text{?} - {h}_{cdQ} {h}_{1 Q} ) + i ( {h}_{cdQ} \text{?} + \text{?} {h}_{1 Q} ) = ( \text{?} {m}_{1} - {h}_{cdQ} {m}_{2} ) + i ( \text{?} {m}_{3} - {h}_{cdQ} {m}_{4} ) ( - {h}_{cdQ} \text{?} + \text{?} {h}_{2 Q} ) + i ( \text{?} - {h}_{cdQ} {h}_{2 Q} ) = ( \text{?} {m}_{5} + {h}_{cdQ} {m}_{6} ) + i ( \text{?} {m}_{7} + {h}_{cdQ} {m}_{8} ) ( \text{?} + {h}_{cdQ} {h}_{3 Q} ) + i ( - {h}_{cdQ} \text{?} + \text{?} {h}_{3 Q} ) = ( \text{?} {m}_{9} + {h}_{cdQ} {m}_{10} ) + i ( \text{?} {m}_{11} + {h}_{cdQ} {m}_{12} ) ( - {h}_{cdQ} \text{?} + \text{?} {h}_{4 Q} ) + i ( - \text{?} - {h}_{cdQ} {h}_{4 Q} ) = ( \text{?} {m}_{13} + {h}_{cdQ} {m}_{14} ) + i ( \text{?} {m}_{15} + {h}_{cdQ} {m}_{16} )$$

$$\text{?} = {m}_{1} = \text{?} + \text{?} ,$$

$${h}_{1 Q} = {m}_{2} = {f}_{1 Q} + {f}_{2 Q} ,$$

$$\text{?} = - {m}_{6} = \text{?} - \text{?} ,$$

$${h}_{2 Q} = - {m}_{5} = {f}_{1 Q} - {f}_{2 Q} ,$$

$$\text{?} = {m}_{9} = \text{?} + \text{?} ,$$

$${h}_{3 Q} = {m}_{10} = {f}_{3 Q} - {f}_{4 Q} ,$$

$$\text{?} = {m}_{14} = \text{?} + \text{?} ,$$

$${h}_{4 Q} = {m}_{13} = {f}_{3 Q} - {f}_{4 Q} ,$$

$$\text{?} \text{indicates text missing or illegible when filed}$$

are obtained. In other words, the equations 2 and 3 above match with each other. Accordingly, it can be said that the digital signal processing in which two sets of a 2×1 WL filter and a chromatic dispersion filter (complex) shown in FIG. 6 are used and digital signal processing in which a 4×1 complex WL filter and chromatic dispersion filters for each of I and Q are used are equivalent.

Next, updating of the filter coefficient in the adaptive equalizer 162 will be described. When an input signal of the 4×1 WL equalizer 190 is denoted by x and an input of the phase compensation filter is denoted by y and y*, y and y* can be expressed by the following equations using x.

$${y}_{i} [ k ] = {\sum }_{j , m} {h}_{ij} [ m ] {x}_{j} [ k - m ]$$

$$\text{?} [ k ] = {\sum }_{j , m} \text{?} [ m ] {x}_{j}^{*} [ k - m ] \text{?}$$

$$\text{?} \text{indicates text missing or illegible when filed}$$

In the equations above, j denotes the number of dimensions of the input, i denotes the number of dimensions of the output, and k denotes the sample. Meanwhile, m denotes the tap count of a filter finite impulse response (FIR) filter. The output z of the adaptive equalizer 162 is expressed by

$${z}_{i} [ k ] = {e}^{- i {θ}_{i}} {y}_{i} [ k ] + {e}^{i {θ}_{i}} {y}_{i *} [ k ] .$$

The loss function φ used to update the filter coefficient is defined by the equation below, with d being a training signal indicating a desired state.

$$ϕ [ k ] = {\sum }_{i} {\vert {d}_{i} [ k ] - {z}_{i} [ k ] \vert}^{2}$$

The filter coefficient of the 4×1 WL equalizer 190 is updated with the use of the stochastic gradient descent so as to minimize the loss function above.

$$\frac{\partial ϕ [ k ]}{\partial {h}_{ij} [ m ]} = \frac{\partial }{\partial {h}_{ij} [ m ]} {\vert {d}_{i} [ k ] - {z}_{i} [ k ] \vert}^{2} = \frac{\partial }{\partial {h}_{ij} [ m ]} ( {d}_{i} [ k ] - {z}_{i} [ k ] ) ( {{d}_{i} [ k ]}^{*} - {{z}_{i} [ k ]}^{*} ) = \frac{\partial }{\partial {h}_{ij} [ m ]} ( {d}_{i} [ k ] - {z}_{i} [ k ] ) {e}_{i}^{*} = {e}_{i}^{*} \frac{\partial }{\partial {h}_{ij} [ m ]} ( {d}_{i} [ k ] - {z}_{i} [ k ] ) = - {e}_{i}^{*} \frac{\partial }{\partial {h}_{ij} [ m ]} {z}_{i} [ k ] = - {e}_{i}^{*} \frac{\partial }{\partial {h}_{ij} [ m ]} ( {e}^{- i {θ}_{i}} {y}_{i} [ k ] + {e}^{i {θ}_{i}} {y}_{i *} [ k ] ) = - {e}^{- i {θ}_{i}} {e}_{i}^{*} \frac{\partial }{\partial {h}_{ij} [ m ]} {y}_{i} [ k ] = - {e}^{- i {θ}_{i}} {e}_{i}^{*} {x}_{j} [ k - m ] .$$

$$\frac{\partial ϕ [ k ]}{\partial {h}_{ij}} = - {e}^{- i {θ}_{i}} {e}_{i}^{*} {x}_{j} [ k ] .$$

$$\frac{\partial ϕ [ k ]}{\partial {( {h}_{ij} )}^{*}} = - {e}^{- i {θ}_{i}} {e}_{i} {x}_{j} [ k ] = - {e}^{- i {θ}_{i}} ( {d}_{i} [ k ] - {z}_{i} [ k ] ) {x}_{j}^{*} [ k ]$$

$$\frac{\partial ϕ [ k ]}{\partial {h}_{ij *} [ m ]} = \frac{\partial }{\partial {h}_{ij *} [ m ]} {\vert {d}_{i} [ k ] - {z}_{i} [ k ] \vert}^{2} = \frac{\partial }{\partial {h}_{ij *} [ m ]} ( {d}_{i} [ k ] - {z}_{i} [ k ] ) ( {{d}_{i} [ k ]}^{*} - {{z}_{i} [ k ]}^{*} ) = \frac{\partial }{\partial {h}_{ij *} [ m ]} ( {d}_{i} [ k ] - {z}_{i} [ k ] ) {e}_{i}^{*} = {e}_{i}^{*} \frac{\partial }{\partial {h}_{ij *} [ m ]} ( {d}_{i} [ k ] - {z}_{i} [ k ] ) = - {e}_{i}^{*} \frac{\partial }{\partial {h}_{ij *} [ m ]} {z}_{i *} [ k ] = - {e}_{i}^{*} \frac{\partial }{\partial {h}_{ij *} [ m ]} ( {e}^{- i {θ}_{i}} {y}_{i} [ k ] + {e}^{i {θ}_{i}} {y}_{i *} [ k ] ) = - {e}^{i {θ}_{i}} {e}_{i}^{*} \frac{\partial }{\partial {h}_{ij *} [ m ]} {y}_{i *} [ k ] = - {e}^{i {θ}_{i}} {e}_{i}^{*} {x}_{j}^{*} [ k - m ]$$

$$\frac{\partial ϕ [ k ]}{\partial {h}_{ij}} = - {e}^{- i {θ}_{i}} {e}_{i}^{*} {x}_{j} [ k ]$$

$$\frac{\partial ϕ [ k ]}{\partial {( {h}_{ij *} )}^{*}} = - {e}^{- i {θ}_{i}} {e}_{i}^{*} {x}_{j} [ k ] = - {e}^{- i {θ}_{i}} ( {d}_{i} [ k ] - {z}_{i} [ k ] ) {x}_{j} [ k ]$$

Based on the above, each filter coefficient after the update is given by the expressions below, with a being the step size that controls the scale of the update.

$${h}_{ij} \to {h}_{ij} - 2 α \frac{\partial ϕ [ k ]}{\partial {( {h}_{ij} )}^{*}}$$

$${h}_{ij} \to {h}_{ij} + 2 α ( {d}_{i} [ k ] - {z}_{i} [ k ] ) {e}^{i {θ}_{i}} {x}_{j}^{*} [ k ]$$

$${h}_{ij *} \to {h}_{ij *} - 2 α \frac{\partial ϕ [ k ]}{\partial {( {h}_{ij *} )}^{*}}$$

$${h}_{ij *} \to {h}_{ij *} + 2 α ( {d}_{i} [ k ] - {z}_{i} [ k ] ) {e}^{- i {θ}_{i}} {x}_{j} [ k ]$$

Meanwhile, the phase compensation coefficients in the phase compensation filter are e^{-iθi} and e^{iθi}.

θᵢ is calculated separately based on φ[k] through a method that is not described in detail herein. The phase compensation amount including a frequency offset and phase noise is calculated with the use of a digital PLL using a typical training signal.

According to the present example embodiment, the digital signal processing unit 154 includes the adaptive equalizer 162 (8×2 complex WL equalizer) and the phase compensation filter 163 included in the 8×2 complex WL equalizer. The filter coefficient updating unit 170 updates the coefficient of the adaptive equalizer 162 with the use of an output signal of the phase compensation filter 163. According to the present example embodiment, the adaptive equalizer 162 performs phase compensation including a frequency offset in the phase compensation filter 163. As such a configuration is adopted, the adaptive equalizer 162 can compensate for the Tx load, the Rx load, the polarization fluctuation (polarization mode dispersion), the frequency offset, and the phase noise of the light source at once. The present example embodiment can reduce the influence that the phase noise of the light source has on the accuracy of equalizing the Tx load and can equalize the Tx load with high accuracy.

The present inventor has conducted simulation to verify the effect of equalization in the digital signal processing unit 154. Used in the simulation is a 130 GB (Baud) polarization-multiplexed 64 QAM signal. To this signal, 100 kHz noise is added as phase noise to each of the transmitter-side LD and the local oscillator light. Furthermore, 0.5 UI (Unit Interval) IQ skew is added to the Q signal of the X-polarization in the transmitter, and −0.5 UI IQ skew is added to the Q signal of the Y-polarization in the receiver. The chromatic dispersion is set to 7.5 ns/nm.

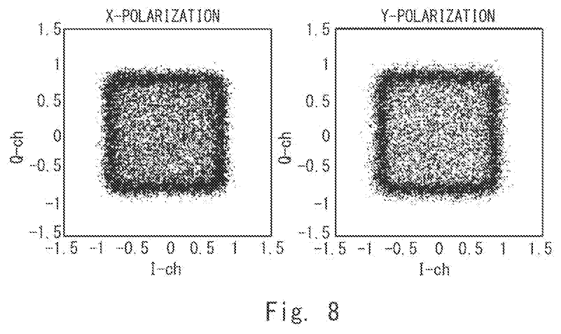

FIG. 8 shows a distribution of signals of the I-channel and the Q-channel observed when neither the Tx load nor the Rx load is compensated for in the equalization digital signal processing. In the simulation, a signal converted to a digital signal by an ADC is equalized with the use of a chromatic dispersion compensation filter, a polarization separation filter, and a carrier phase compensation filter. In this case, neither the Tx load nor the Rx load is compensated for in the equalization digital signal processing, and this makes it difficult to differentiate the signal points in both the X-polarization and the Y-polarization.

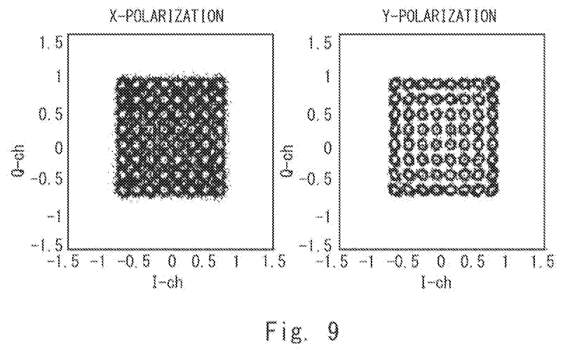

FIG. 9 shows a distribution of signals of the I-channel and the Q-channel observed when equalization equivalent to the adaptive equalization described in Patent Literature 1 is performed in the equalized digital signal processing. In the simulation, a signal converted to a digital signal by an ADC is equalized with the use of a chromatic dispersion compensation filter, an 8×2 MIMO filter, a frequency offset compensation filter, and carrier phase compensation filter. In this case, distortion appears to improve in the Y-polarization to which the IQ skew is added in the receiver. However, although improvement in the reception can be observed in the signal of the X-polarization to which the IQ skew is added in the transmitter as compared to the case shown in FIG. 8, the reception characteristics are not sufficiently high.

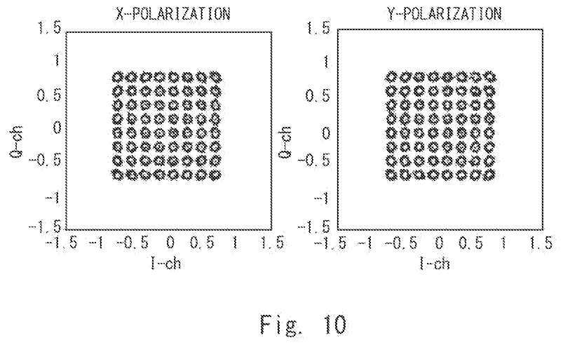

FIG. 10 shows a distribution of signals of the I-channel and the Q-channel observed when the digital signal processing unit 154 according to the present example embodiment is used. Comparison of FIG. 10 with FIGS. 8 and 9 shows that the reception characteristics of the signals of both the X-polarization and the Y-polarization improve when the digital signal processing unit 154 is used. In this manner, the simulation has confirmed that the present example embodiment can equalize the Tx load with high accuracy.

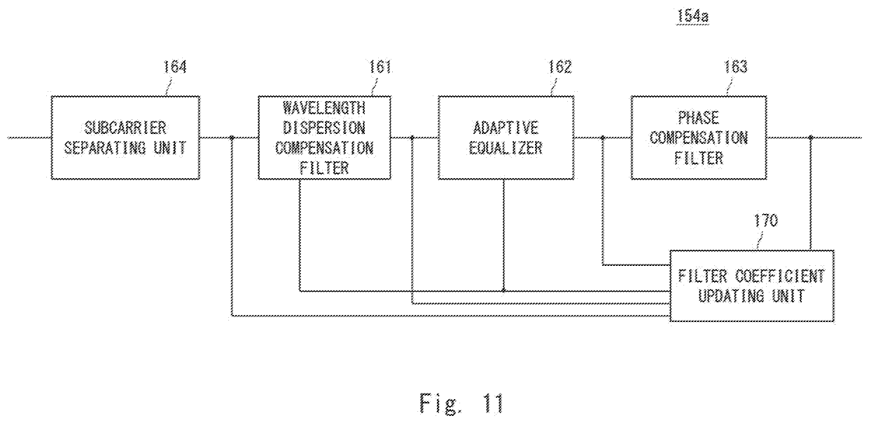

Next, a second example embodiment of the present disclosure will be described. FIG. 11 shows an example of a configuration of a digital signal processing unit used in the second example embodiment of the present disclosure. According to the present example embodiment, a digital signal processing unit 154a includes, in addition to the components of the digital signal processing unit 154 shown in FIG. 4, a subcarrier separating unit 164. The filter coefficients in the digital signal processing unit 154a may be updated in a manner similar to how the filter coefficients are updated according to the first example embodiment.

According to the present example embodiment, a reception signal is polarization-multiplexed and is also subcarrier-multiplexed. The subcarrier includes two subcarriers: a first subcarrier SC1 and a second subcarrier SC2. The first subcarrier SC1 and the second subcarrier SC2 are subcarriers forming a pair. The subcarrier may include four subcarriers: first to fourth subcarriers SC1 to SC4. In this case, the first subcarrier SC1 and the fourth subcarrier SC4 form a pair, and the second subcarrier SC2 and the third subcarrier SC3 form a pair.

Subcarrier-multiplexing on the transmitter side will be described. The optical transmitter 110 (see FIG. 3) further includes, for example, a subcarrier-multiplexed signal processing unit disposed between the encoding unit 111 and the pre-equalization unit 112. The subcarrier-multiplexed signal processing unit includes a plurality of fast Fourier transform (FFT) units corresponding to the number of the subcarriers, a subcarrier allocation unit, and an inverse FFT (IFFT) unit.

In the subcarrier-multiplexed signal processing unit, transmission data is separated into a plurality of subcarrier signals, and the separated subcarrier signals are input to the plurality of FFT units. Each FFT performs FFT on the input subcarrier signal and converts the subcarrier signal to a subcarrier FFT signal in the frequency domain. The subcarrier allocation unit frequency-shifts the subcarrier FFT signal in the frequency domain by the frequency shift amount of each subcarrier, and generates a subcarrier allocation signal in which the frequency-shifted signal is allocated to the frequency domain. The IFFT unit performs IFFT on the subcarrier allocation signal in the frequency domain and converts the subcarrier allocation signal to a subcarrier-multiplexed signal in the time domain.

Next, subcarrier separation on the receiver side will be described. The subcarrier separating unit 164 includes an FFT unit, a separating unit, and a plurality of IFFT units corresponding to the number of the subcarriers. The subcarrier separating unit 164 receives input of a digital subcarrier-multiplexed signal from the ADC 153 (see FIG. 3). The FFT unit performs FFT on the input subcarrier-multiplexed signal and converts the subcarrier-multiplexed signal to a subcarrier-multiplexed FFT signal in the frequency domain. The subcarrier separating unit separates the plurality of subcarrier signals included in the subcarrier-multiplexed FFT signal in the frequency domain into the respective subcarriers. The subcarrier separation signal generates a plurality of subcarrier separation signals corresponding to the number of the subcarriers. Each IFFT unit converts a subcarrier separation signal, a signal in the frequency domain, into a signal in the time domain. Although FIG. 11 shows an example in which the subcarrier separating unit 164 is disposed before the chromatic dispersion compensation filter 161, the present example embodiment is not limited to this example. The subcarrier separating unit 164 may be disposed between the chromatic dispersion compensation filter 161 and the adaptive equalizer 162.

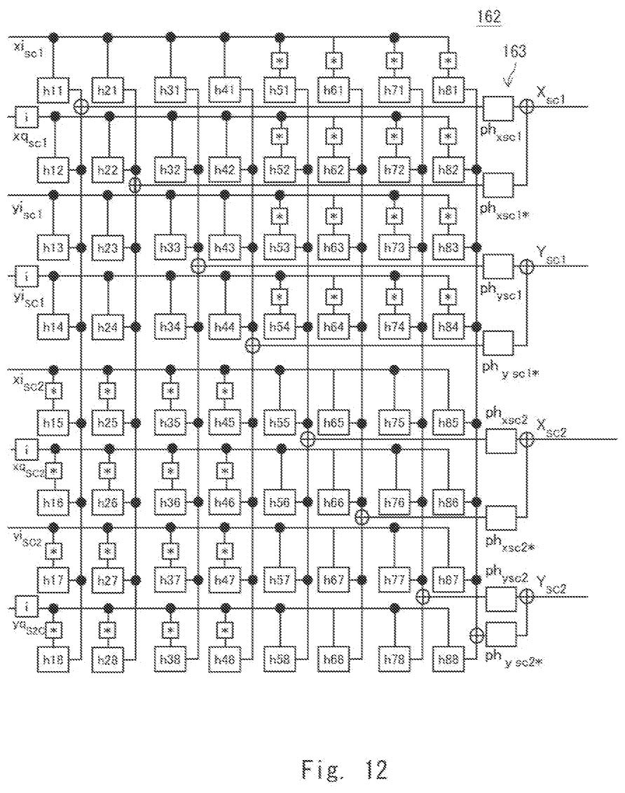

FIG. 12 shows an example of a configuration of the adaptive equalizer 162 that includes the phase compensation filter 163. In this example, the adaptive equalizer 162 includes a 16×4 complex WL equalizer (also referred to below as 16×4 WL MIMO filter). The 16×4 WL MIMO filter receives input of a signal in which the chromatic dispersion is individually compensated for in I and Q for each subcarrier in the chromatic dispersion compensation filter 161. Specifically, the 16×4 WL MIMO filter receives input of the IQ components (xi_{SC1}, xq_{SC1}, yi_{SC1}, yq_{SC1}, xi_{SC2}, xq_{SC2}, yi_{SC2}, yq_{SC2}) of each of the X-polarization and the Y-polarization of the two subcarriers.

In the 16×4 WL MIMO filter, each complex coefficient filter multiplies the input signal and the phase conjugate of the input signal by a complex impulse response. Then, xi_{SC1}, xq_{SC1}, yi_{SC1}, and yq_{SC1} of the first subcarrier multiplied by the complex impulse response and the phase conjugates xi_{SC2}*, xq_{SC2}*, yi_{SC2}* and, yq_{SC2}* of the second subcarrier are added in an adder, and are output, for each polarization, to the phase compensation filters 163 whose coefficients are ph_{xSC1}, ph_{xSC1}*, ph_{ySC1}, and ph_{ySC1}*. The output of the phase compensation filter whose coefficient is ph_{xSC1} and the output of the phase compensation filter whose coefficient is ph_{xSC1}* are added in an adder, and the added signals are output as a signal X_{SC1} of the X-polarization of the first subcarrier. The output of the phase compensation filter whose coefficient is ph_{ySC1} and the output of the phase compensation filter whose coefficient is ph_{ySC1}* are added in an adder, and the added signals are output as a signal Y_{SC1} of the Y-polarization of the first subcarrier.

Meanwhile, xi_{SC2}, xq_{SC2}, yi_{SC2}, and yq_{SC2} of the second subcarrier multiplied by the complex impulse response and the phase conjugates xi_{SC1}*, xq_{SC1}*, yi_{SC1}*, and yq_{SC1}* of the first subcarrier are added in an adder, and are output, for each polarization, to the phase compensation filters 163 whose coefficients are ph_{xSC2}, ph_{xSC2}*, ph_{ySC2}, and ph_{ySC2}*. The output of the phase compensation filter whose coefficient is ph_{xSC2} and the output of the phase compensation filter whose coefficient is ph_{xSC2}+ are added in an adder, and the added signals are output as a signal X_{SC2} of the X-polarization of the second subcarrier. The output of the phase compensation filter whose coefficient is ph_{ySC2} and the output of the phase compensation filter whose coefficient is ph_{ySC2}* are added in an adder, and the added signals are output as a signal Y_{SC2} of the Y-polarization of the second subcarrier.

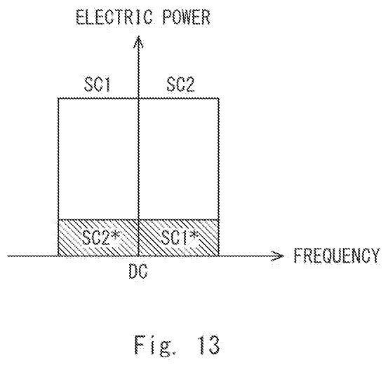

FIG. 13 schematically shows an example of a waveform observed after subcarrier combining. In FIG. 13, the horizontal axis represents the frequency, and the vertical axis represents the electric power. In a signal in which subcarriers are multiplexed, when the frequency characteristics of the I component differ from the frequency characteristics of the Q component, a conjugate component SC2* of the second subcarrier is produced in the first subcarrier SC1 due to the IQ mixing. Meanwhile, a conjugate component SC1* of the first subcarrier is produced in the second subcarrier SC2 due to the IQ mixing. In other words, IQ mixing resulting from the conjugate components of the respective subcarriers SC occurs. The conjugate component of each subcarrier is produced in the pair-forming subcarrier SC.

In the 16×4 WL MIMO filter above, the phase conjugate of the second subcarrier SC2 is added to the signal of the first subcarrier SC1, and the phase conjugate of the first subcarrier SC1 is added to the signal of the second subcarrier SC2. This configuration makes it possible to correct distortion without being affected by the IQ mixing in the adaptive equalizer 162. The number of subcarriers is not limited to two, and four or more subcarriers may be multiplexed in a reception signal. In that case, one 16×4 WL MIMO filter may be disposed for every two subcarriers forming a pair. Other advantageous effects are similar to the advantageous effects described according to the first example embodiment.

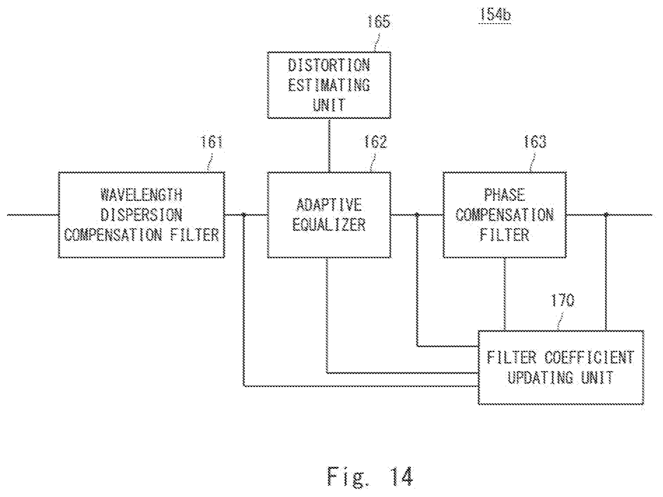

Next, a third example embodiment of the present disclosure will be described. FIG. 14 shows an example of a configuration of a digital signal processing unit used in the third example embodiment of the present disclosure. According to the present example embodiment, a digital signal processing unit 154b includes, in addition to the components of the digital signal processing unit 154 shown in FIG. 4, a distortion estimating unit 165. The distortion estimating unit 165 estimates the Tx load based on the filter coefficient of the adaptive equalizer 162. The filter coefficients in the digital signal processing unit 154b may be updated in a manner similar to how the filter coefficients are updated according to the first example embodiment. The present example embodiment can be applied also to a configuration in which subcarrier multiplexing is used as described according to the second example embodiment.

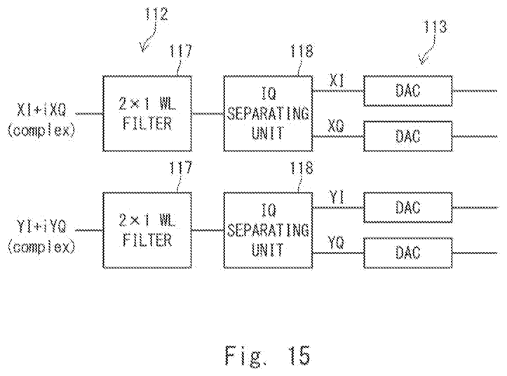

According to the present example embodiment, the filter coefficient of the pre-equalization unit 112 (see FIG. 3) of the optical transmitter 110 is controlled based on the filter coefficient of the digital signal processing unit 154b on the receiver side. FIG. 15 shows part of a configuration of the optical transmitter 110. The optical transmitter 110 includes a 2×1 WL filter 117 and an IQ separating unit 118 corresponding to each of the X-polarization and the Y-polarization. The 2×1 WL filters 117 correspond to the pre-equalization unit 112 shown in FIG. 3. The 2×1 WL filter 117 disposed for the X-polarization receives input of a complex signal (XI+iXQ) of the X-polarization. An output signal of this 2×1 WL filter 117 is separated into an I-component real signal and a Q-component real signal in the IQ separating unit 118, and these signals are converted to analog signals by the DACs 113. The 2×1 WL filter 117 disposed for the Y-polarization receives input of a complex signal (YI+iYQ) of the Y-polarization. An output signal of this 2×1 WL filter 117 is separated into an I-component real signal and a Q-component real signal in the IQ separating unit 118, and these signals are converted to analog signals by the DACs 113.

The distortion estimating unit 165 (see FIG. 14) estimates the Tx load from the filter coefficient of the adaptive equalizer 162 held after the coefficient convergence. The Tx load can be calculated based on the filter coefficient that is multiplied by the complex impulse response shown in FIG. 5. According to the present example embodiment, the filter coefficient of the 2×1 WL filter of the pre-equalization unit 112 is set so that the characteristics reverse to the characteristics of the Tx load estimated by the distortion estimating unit 165 are added to the signal to be transmitted in the pre-equalization unit 112. As the filter coefficient of the pre-equalization unit 112 is set in accordance with the Tx load estimated on the receiver side, the Tx load can be compensated for on the transmitter side.

Herein, a real signal-input real coefficient MIMO filter may be used for the pre-equalization unit 112 on the transmitter side. When a 2×2 Real MIMO filter is used in the pre-equalization unit 112, characteristics reverse to those of the Tx load estimated from the 8×2 WL MIMO filter may be converted to the coefficient of the 2×2 Real MIMO filter.

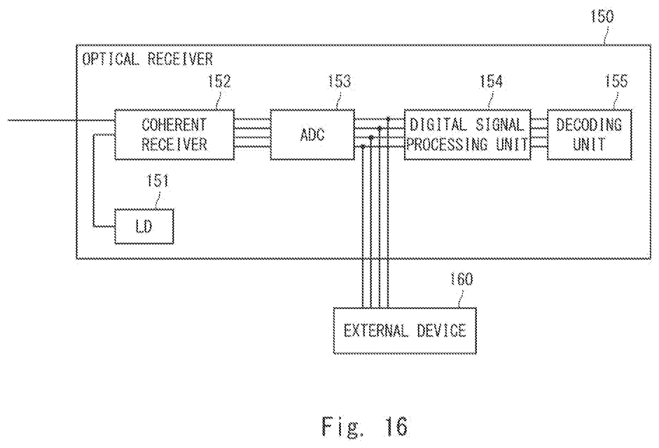

According to the present example embodiment, part or the whole of the digital signal processing shown in FIG. 4 or 5 may be provided in hardware different from the digital signal processing unit 154b. FIG. 16 shows an optical receiver used in a modified example. In this modified example, the optical receiver 150 is connected to an external device 160. The external device 160 is constituted, for example, by a computer device, such as a personal computer (PC). In the optical receiver 150, a digital signal that the ADC 153 outputs is branched to the external device 160. The optical receiver 150 includes an interface for connecting to the external device 160 and outputs a digital signal to the external device 160 via this interface.

The external device 160 reproduces an operation of the chromatic dispersion compensation filter 161, the adaptive equalizer 162, and the phase compensation filter 163 through, for example, simulation, and updates the filter coefficients. In the external device 160, a chromatic dispersion compensation filter, an 8×2 WL equalizer, and a phase compensation filter may be implemented by dedicated hardware. The external device 160 estimates the Tx load based on the updated filter coefficient of the 8×2 WL equalizer. The external device 160 may transmit the filter coefficient of the pre-equalization unit 112 to the optical transmitter 110 and update the filter coefficient of the pre-equalization unit 112. Alternatively, the filter coefficient corresponding to the Tx load estimated by the external device 160 may be set manually in the pre-equalization unit 112. According to the present example embodiment, when the Tx load is estimated in the external device 160, the digital signal processing unit 154 does not have to include the filter for compensating for the Tx load.

Furthermore, according to the present example embodiment, the external device 160 (its distortion estimating unit) may estimate the Rx load from the filter coefficient of the 8×2 WL equalizer held after the coefficient convergence. The Rx load can be calculated based on the filter coefficient that is multiplied by the complex impulse response shown in FIG. 5. In FIG. 16, the digital signal processing unit 154 includes a filter that compensates for in-receiver distortion. The filter coefficient of the in-receiver distortion compensation filter may be set such that the characteristics reverse to the characteristics of the estimated Rx load are given to the reception signal.

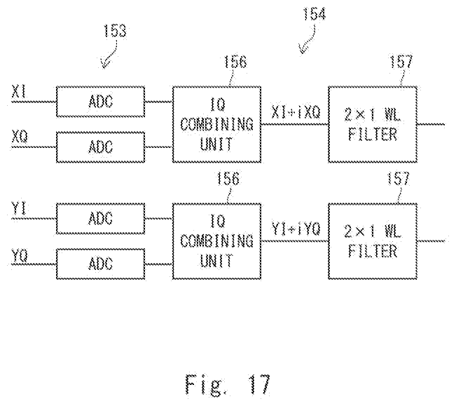

FIG. 17 shows part of a configuration of the optical receiver 150. In the optical receiver 150, the digital signal processing unit 154 includes an IQ combining unit 156 and a 2×1 WL filter 157 corresponding to each of the X-polarization and the Y-polarization. The 2×1 WL filter 157 is an equalizing unit that performs equalization processing on the polarization-multiplexed optical signal coherently received in the optical receiver 150. The IQ combining unit 156 disposed for the X-polarization combines real signals XI and XQ converted to digital signals in the ADCs 153 into a complex signal (XI+iXQ) of the X-polarization. The 2×1 WL filter 157 disposed for the X-polarization receives input of the complex signal (XI+iXQ) of the X-polarization. Meanwhile, the IQ combining unit 156 disposed for the Y-polarization combines real signals YI and YQ converted to digital signals in the ADCs 153 into a complex signal (YI+iYQ) of the Y-polarization. The 2×1 WL filter 157 disposed for the Y-polarization receives input of the complex signal (XI+iXQ) of the Y-polarization.

The external device 160 sets the filter coefficients of the 2×1 WL filters 157 of the respective polarizations based on the estimated Rx load. Alternatively, the filter coefficients corresponding to the Rx load estimated by the external device 160 may be set manually in the 2×1 WL filters 157 of the respective polarizations. This configuration makes it possible to compensate for in-transmitter distortion with the use of the 2×1 WL 157 of each polarization. In this case, an existing circuit can be used for the digital signal processing unit 154 used to receive signals.

According to the present example embodiment, the distortion estimating unit 165 estimates the Tx load from the filter coefficient of the adaptive equalizer 162 held after the coefficient convergence. As the filter coefficient of the pre-equalization unit 112 in the optical transmitter 110 is controlled based on the Tx load estimated on the receiver side, the Tx load can be compensated for on the transmitter side. Furthermore, the distortion estimating unit 165 can estimate the Rx load from the filter coefficient of the adaptive equalizer 162 held after the coefficient convergence. As the filter coefficient of the in-receiver distortion compensation filter of the digital signal processing unit 154 in the optical receiver 150 is controlled based on the estimated Rx load, the Rx load can be compensated for.

Thus far, some example embodiments of the present disclosure have been described in detail, but the foregoing example embodiments do limit the present disclosure. An example embodiment obtained by making a change or modification to the foregoing example embodiments within a scope that does not depart from the scope and spirit of the present disclosure is also encompassed by the present disclosure.

For example, part or the whole of the foregoing example embodiments can also be expressed as in the following supplementary notes, which are not limiting.

### [Supplementary Note 1]

A digital signal processing circuit including:
a chromatic dispersion compensation filter configured to multiply each of a real component and an imaginary component of each of a first polarization and a second polarization of a polarization-multiplexed optical signal transmitted from a transmitter and received by a receiver by a filter coefficient that compensates for chromatic dispersion;
an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals; and
a filter coefficient updating unit configured to update the phase rotation for the carrier phase compensation and the complex impulse response that is multiplied by the adaptive equalizer, by use of an output of the adaptive equalizer.

### [Supplementary Note 2]

The digital signal processing circuit according to Supplementary Note 1, wherein the adaptive equalizer includes a complex 8×2 widely linear (WL) MIMO filter.

### [Supplementary Note 3]

The digital signal processing circuit according to Supplementary Note 2, wherein the 8×2 WL MIMO filter is a WL filter configured to receive input of a complex signal indicating the real component and a complex signal indicating the imaginary component of the first polarization, a complex signal indicating the real component and a complex signal indicating the imaginary component of the second polarization, a complex signal indicating the phase conjugate of the real component and a complex signal indicating the phase conjugate of the imaginary component of the first polarization, and a complex signal indicating the phase conjugate of the real component and a complex signal indicating the phase conjugate of the imaginary component of the second polarization, and to output a complex signal of the first polarization and a complex signal of the second polarization.

### [Supplementary Note 4]

The digital signal processing circuit according to Supplementary Note 1, wherein
the polarization-multiplexed optical signal is a digital subcarrier-multiplexed optical signal in which data is multiplexed into a plurality of subcarriers,
the plurality of subcarriers include a pair of a first subcarrier and a second subcarrier, and
the adaptive equalizer is configured
   to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
   to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

### [Supplementary Note 5]

The digital signal processing circuit according to Supplementary Note 4, wherein the adaptive equalizer includes a complex 16×4 widely linear (WL) MIMO filter.

### [Supplementary Note 6]

The digital signal processing circuit according to Supplementary Note 5, wherein the 16×4 WL MIMO filter is a WL filter configured to receive input of a complex signal indicating the real component and a complex signal indicating the imaginary component of the first polarization of the first subcarrier, a complex signal indicating the real component and a complex signal indicating the imaginary component of the second polarization of the first subcarrier, a complex signal indicating the real component and a complex signal indicating the imaginary component of the first polarization of the second subcarrier, a complex signal indicating the real component and a complex signal indicating the imaginary component of the second polarization of the second subcarrier, a complex signal indicating the phase conjugate of the real component and a complex signal indicating the phase conjugate of the imaginary component of the first polarization of the first subcarrier, a complex signal indicating the phase conjugate of the real component and a complex signal indicating the phase conjugate of the imaginary component of the second polarization of the first subcarrier, a complex signal indicating the phase conjugate of the real component and a complex signal indicating the phase conjugate of the imaginary component of the first polarization of the second subcarrier, and a complex signal indicating the phase conjugate of the real component and a complex signal indicating the phase conjugate of the imaginary component of the second polarization of the second subcarrier, and to output a complex signal of the first polarization and a complex signal of the second polarization of the first subcarrier and a complex signal of the first polarization and a complex signal of the second polarization of the second subcarrier.

### [Supplementary Note 7]

The digital signal processing circuit according to any one of Supplementary Notes 1 to 6, further including a distortion estimating unit configured to estimate at least one of distortion produced in the transmitter or distortion produced in the receiver, based on the complex impulse response in the adaptive equalizer.

### [Supplementary Note 8]

The digital signal processing circuit according to any one of Supplementary Notes 1 to 7, wherein the adaptive equalizer is configured to compensate for distortion produced in the transmitter, distortion produced in the receiver, polarization mode dispersion, frequency offset, or phase noise of a light source.

### [Supplementary Note 9]

A receiver including:
a detector configured to coherently receive a polarization-multiplexed optical signal transmitted from a transmitter via a transmission line; and
a digital signal processing circuit configured to perform equalization signal processing on the reception signal coherently received,
wherein the digital signal processing circuit includes
   a chromatic dispersion compensation filter configured to multiply each of a real component and an imaginary component of each of a first polarization and a second polarization of the reception signal by a filter coefficient that compensates for chromatic dispersion,
   an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals, and
   a filter coefficient updating unit configured to update the phase rotation for the carrier phase compensation and the complex impulse response that is multiplied by the adaptive equalizer, by use of an output of the adaptive equalizer.

### [Supplementary Note 10]

The receiver according to Supplementary Note 9, wherein the adaptive equalizer includes a complex 8×2 widely linear (WL) MIMO filter.

### [Supplementary Note 11]

The receiver according to Supplementary Note 9, wherein
the polarization-multiplexed optical signal is a digital subcarrier-multiplexed optical signal in which data is multiplexed into a plurality of subcarriers,
the plurality of subcarriers include a pair of a first subcarrier and a second subcarrier, and
the adaptive equalizer is configured
   to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
   to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

### [Supplementary Note 12]

The receiver according to Supplementary Note 11, wherein the adaptive equalizer includes a complex 16×4 widely linear (WL) MIMO filter.

### [Supplementary Note 13]

A communication system including:
a transmitter configured to transmit a polarization-multiplexed optical signal via a transmission line;
a receiver including a detector configured to coherently receive the polarization-multiplexed optical signal transmitted from the transmitter; and
a digital signal processing circuit configured to perform equalization signal processing on the reception signal coherently received,
wherein the digital signal processing circuit includes
   a chromatic dispersion compensation filter configured to multiply each of a real component and an imaginary component of each of a first polarization and a second polarization of the reception signal by a filter coefficient that compensates for chromatic dispersion,
   an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals, and
   a filter coefficient updating unit configured to update the phase rotation for the carrier phase compensation and the complex impulse response that is multiplied by the adaptive equalizer, by use of an output of the adaptive equalizer.

### [Supplementary Note 14]

The communication system according to Supplementary Note 13, wherein the adaptive equalizer includes a complex 8×2 widely linear (WL) MIMO filter.

### [Supplementary Note 15]

The communication system according to Supplementary Note 13, wherein
the polarization-multiplexed optical signal is a digital subcarrier-multiplexed optical signal in which data is multiplexed into a plurality of subcarriers,
the plurality of subcarriers include a first subcarrier and a second subcarrier forming a pair, and
the adaptive equalizer is configured
   to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
   to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

### [Supplementary Note 16]

The communication system according to Supplementary Note 15, wherein the adaptive equalizer includes a complex 16×4 widely linear (WL) MIMO filter.

### [Supplementary Note 17]

The communication system according to any one of Supplementary Notes 13 to 16, wherein
the transmitter includes a pre-equalization unit configured to pre-equalize the polarization-multiplexed optical signal, and
a filter coefficient of the pre-equalization unit is controlled in accordance with distortion produced in the transmitter, which is estimated based on a filter coefficient of the adaptive equalizer.

### [Supplementary Note 18]

The communication system according to any one of Supplementary Notes 13 to 17, wherein
the receiver includes an equalizing unit configured to perform equalization processing on the polarization-multiplexed optical signal coherently received, and
a filter coefficient of the equalizing unit is controlled in accordance with distortion produced in the receiver, which is estimated based on a filter coefficient of the adaptive equalizer.

### [Supplementary Note 19]

A digital signal processing method including:
multiplying, by a chromatic dispersion compensation filter, each of a real component and an imaginary component of each of a first polarization and a second polarization of a polarization-multiplexed optical signal transmitted from a transmitter and received by a receiver by a filter coefficient that compensates for chromatic dispersion;
multiplying, by an adaptive equalizer configured to receive input of signals indicating a real component and an imaginary component of the first polarization output from the chromatic dispersion compensation filter and signals indicating a real component and an imaginary component of the second polarization output from the chromatic dispersion compensation filter, each of the signals indicating the real component and the imaginary component of the first polarization and the signals indicating the real component and the imaginary component of the second polarization by a complex impulse response, adding the signals each multiplied by the complex impulse response, subjecting the added signals to phase rotation for carrier phase compensation including a frequency offset for each polarization, multiplying each of signals indicating phase conjugates of the real component and the imaginary component of the first polarization and signals indicating phase conjugates of the real component and the imaginary component of the second polarization by a complex impulse response, adding the signals each multiplied by the complex impulse response, subjecting the added signals to rotation reverse to the phase rotation for the carrier phase compensation for each polarization, adding, for each polarization, the signals subjected to the phase rotation for the carrier phase compensation and the signals subjected to the rotation reverse to the phase rotation for the carrier phase compensation, and outputting the added signals; and
updating the phase rotation for the carrier phase compensation and the complex impulse response that is multiplied by the adaptive equalizer, by use of an output of the adaptive equalizer.

### REFERENCE SIGNS LIST

10: COMMUNICATION SYSTEM
11: TRANSMITTER
15: RECEIVER
13: TRANSMISSION LINE
21: DETECTOR
22: DIGITAL SIGNAL PROCESSING CIRCUIT
31: CHROMATIC DISPERSION COMPENSATION FILTER
32: ADAPTIVE EQUALIZER
33: FILTER COEFFICIENT UPDATING UNIT
100: OPTICAL FIBER COMMUNICATION SYSTEM
110: OPTICAL TRANSMITTER
130: TRANSMISSION LINE
150: OPTICAL RECEIVER
111: ENCODING UNIT
112: PRE-EQUALIZATION UNIT
113: DAC
114: OPTICAL MODULATOR
115: LD
117: 2×1 WL FILTER
118: IQ SEPARATING UNIT
132: OPTICAL FIBER
133: OPTICAL AMPLIFIER
151: LD
152: COHERENT RECEIVER
153: ADC
154: DIGITAL SIGNAL PROCESSING UNIT
155: DECODING UNIT
156: IQ COMBINING UNIT
157: 2×1 WL FILTER
160: EXTERNAL DEVICE
161: CHROMATIC DISPERSION COMPENSATION FILTER
162: ADAPTIVE EQUALIZER
163: PHASE COMPENSATION FILTER
164: SUBCARRIER SEPARATING UNIT
165: DISTORTION ESTIMATING UNIT
170: FILTER COEFFICIENT UPDATING UNIT
190: 4×1 WL EQUALIZER

What is claimed is:

1. A digital signal processing circuit comprising:
a chromatic dispersion compensation filter configured to multiply each of a real component and an imaginary component of each of a first polarization and a second polarization of a polarization-multiplexed optical signal transmitted from a transmitter and received by a receiver by a filter coefficient that compensates for chromatic dispersion;
an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals; and
at least one memory storing instructions; and
at least one processor configured to execute the instructions to update the phase rotation for the carrier phase compensation and the complex impulse response that is multiplied by the adaptive equalizer, by use of an output of the adaptive equalizer.

2. The digital signal processing circuit according to claim 1, wherein the adaptive equalizer includes a complex 8×2 widely linear (WL) MIMO filter.

3. The digital signal processing circuit according to claim 2, wherein the 8×2 WL MIMO filter is a WL filter configured to receive input of a complex signal indicating the real component and a complex signal indicating the imaginary component of the first polarization, a complex signal indicating the real component and a complex signal indicating the imaginary component of the second polarization, a complex signal indicating the phase conjugate of the real component and a complex signal indicating the phase conjugate of the imaginary component of the first polarization, and a complex signal indicating the phase conjugate of the real component and a complex signal indicating the phase conjugate of the imaginary component of the second polarization, and to output a complex signal of the first polarization and a complex signal of the second polarization.

4. The digital signal processing circuit according to claim 1, wherein
the polarization-multiplexed optical signal is a digital subcarrier-multiplexed optical signal in which data is multiplexed into a plurality of subcarriers,
the plurality of subcarriers include a pair of a first subcarrier and a second subcarrier, and
the adaptive equalizer is configured
to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

5. The digital signal processing circuit according to claim 4, wherein the adaptive equalizer includes a complex 16×4 widely linear (WL) MIMO filter.

6. The digital signal processing circuit according to claim 5, wherein the 16×4 WL MIMO filter is a WL filter configured to receive input of a complex signal indicating the real component and a complex signal indicating the imaginary component of the first polarization of the first subcarrier, a complex signal indicating the real component and a complex signal indicating the imaginary component of the second polarization of the first subcarrier, a complex signal indicating the real component and a complex signal indicating the imaginary component of the first polarization of the second subcarrier, a complex signal indicating the real component and a complex signal indicating the imaginary component of the second polarization of the second subcarrier, a complex signal indicating the phase conjugate of the real component and a complex signal indicating the phase conjugate of the imaginary component of the first polarization of the first subcarrier, a complex signal indicating the phase conjugate of the real component and a complex signal indicating the phase conjugate of the imaginary component of the second polarization of the first subcarrier, a complex signal indicating the phase conjugate of the real component and a complex signal indicating the phase conjugate of the imaginary component of the first polarization of the second subcarrier, and a complex signal indicating the phase conjugate of the real component and a complex signal indicating the phase conjugate of the imaginary component of the second polarization of the second subcarrier, and to output a complex signal of the first polarization and a complex signal of the second polarization of the first subcarrier and a complex signal of the first polarization and a complex signal of the second polarization of the second subcarrier.

7. The digital signal processing circuit according to claim 1, at least one processor is further configured to execute the instructions to estimate at least one of distortion produced in the transmitter or distortion produced in the receiver, based on the complex impulse response in the adaptive equalizer.

8. The digital signal processing circuit according to claim 1, wherein the adaptive equalizer is configured to compensate for distortion produced in the transmitter, distortion produced in the receiver, polarization mode dispersion, frequency offset, or phase noise of a light source.

9. A receiver comprising:
a detector configured to coherently receive a polarization-multiplexed optical signal transmitted from a transmitter via a transmission line; and
a digital signal processing circuit configured to perform equalization signal processing on the reception signal coherently received,
wherein the digital signal processing circuit includes
a chromatic dispersion compensation filter configured to multiply each of a real component and an imaginary component of each of a first polarization and a second polarization of the reception signal by a filter coefficient that compensates for chromatic dispersion,
an adaptive equalizer configured to receive input of signals indicating the real component and the imaginary component of the first polarization output from the chromatic dispersion compensation filter and signals indicating the real component and the imaginary component of the second polarization output from the chromatic dispersion compensation filter, to multiply each of the input signals indicating the real component and the imaginary component of the first polarization and the input signals indicating the real component and the imaginary component of the second polarization by a complex impulse response, to add the signals each multiplied by the complex impulse response, and to subject the added signals to phase rotation for carrier phase compensation including a frequency offset for each polarization, and further configured to multiply each of signals indicating phase conjugates of the real component and the imaginary component of the first polarization input and signals indicating phase conjugates of the real component and the imaginary component of the second polarization input by a complex impulse response, to add the signals each multiplied by the complex impulse response, to subject the added signals to rotation reverse to the phase rotation for the carrier phase compensation for each polarization, to add, for each polarization, the signals subjected to the phase rotation for the carrier phase compensation and the signals subjected to the rotation reverse to the phase rotation for the carrier phase compensation, and to output the added signals, and
at least one memory storing instructions; and
at least one processor configured to execute the instructions to update the phase rotation for the carrier phase compensation and the complex impulse response that is multiplied by the adaptive equalizer, by use of an output of the adaptive equalizer.

10. The receiver according to claim 9, wherein the adaptive equalizer includes a complex 8×2 widely linear (WL) MIMO filter.

11. The receiver according to claim 9, wherein
the polarization-multiplexed optical signal is a digital subcarrier-multiplexed optical signal in which data is multiplexed into a plurality of subcarriers,
the plurality of subcarriers include a first subcarrier and a second subcarrier forming a pair, and
the adaptive equalizer is configured
to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

12. The receiver according to claim 11, wherein the adaptive equalizer includes a complex 16×4 widely linear (WL) MIMO filter.

13. A communication system comprising:
a transmitter configured to transmit a polarization-multiplexed optical signal via a transmission line;
the receiver according to claim 9.

14. The communication system according to claim 13, wherein the adaptive equalizer includes a complex 8×2 widely linear (WL) MIMO filter.

15. The communication system according to claim 13, wherein
the polarization-multiplexed optical signal is a digital subcarrier-multiplexed optical signal in which data is multiplexed into a plurality of subcarriers,
the plurality of subcarriers include a pair of a first subcarrier and a second subcarrier, and
the adaptive equalizer is configured
to multiply, for the first subcarrier, each of signals indicating the real component and the imaginary component of the first polarization and signals indicating the real component and the imaginary component of the second polarization by a complex impulse response, to multiply, for the second subcarrier, each of signals indicating the phase conjugates of the real component and the imaginary component of the first polarization and signals indicating the phase conjugates of the real component and the imaginary component of the second polarization by a complex impulse response, to add the signals of the first subcarrier and the signals of the second subcarrier each multiplied by the complex impulse response, and to subject the added signals to the phase rotation for the carrier phase compensation and the rotation reverse to the phase rotation for the carrier phase compensation for each of the subcarriers and for each of the polarizations, and
to multiply, for the second subcarrier, each of signals indicating the real component and the imaginary component of the first polarization and signals indicating the real component and the imaginary component of the second polarization by a complex impulse response, to multiply, for the first subcarrier, each of signals indicating the phase conjugates of the real component and the imaginary component of the first polarization and signals indicating the phase conjugates of the real component and the imaginary component of the second polarization by a complex impulse response, to add the signals of the second subcarrier and the signals of the first subcarrier each multiplied by the complex impulse response, and to perform the phase rotation for the carrier phase compensation and the rotation reverse to the phase rotation for the carrier phase compensation for each of the subcarriers and for each of the polarizations.

16. The communication system according to claim 15, wherein the adaptive equalizer includes a complex 16×4 widely linear (WL) MIMO filter.

17. The communication system according to claim 13, wherein
the transmitter includes a pre-equalizer configured to pre-equalize the polarization-multiplexed optical signal, and
a filter coefficient of the pre-equalizer is controlled in accordance with distortion produced in the transmitter, which is estimated based on a filter coefficient of the adaptive equalizer.

18. The communication system according to claim 13, wherein
the receiver includes an equalizer configured to perform equalization processing on the polarization-multiplexed optical signal coherently received, and
a filter coefficient of the equalizer is controlled in accordance with distortion produced in the receiver, which is estimated based on a filter coefficient of the adaptive equalizer.

19. A digital signal processing method comprising:
multiplying, by a chromatic dispersion compensation filter, each of a real component and an imaginary component of each of a first polarization and a second polarization of a polarization-multiplexed optical signal transmitted from a transmitter and received by a receiver by a filter coefficient that compensates for chromatic dispersion;
multiplying, by an adaptive equalizer configured to receive input of signals indicating a real component and an imaginary component of the first polarization output from the chromatic dispersion compensation filter and signals indicating a real component and an imaginary component of the second polarization output from the chromatic dispersion compensation filter, each of the signals indicating the real component and the imaginary component of the first polarization and the signals indicating the real component and the imaginary component of the second polarization by a complex impulse response, adding the signals each multiplied by the complex impulse response, subjecting the added signals to phase rotation for carrier phase compensation including a frequency offset for each polarization, multiplying each of signals indicating phase conjugates of the real component and the imaginary component of the first polarization and signals indicating phase conjugates of the real component and the imaginary component of the second polarization by a complex impulse response, adding the signals each multiplied by the complex impulse response, subjecting the added signals to rotation reverse to the phase rotation for the carrier phase compensation for each polarization, adding, for each polarization, the signals subjected to the phase rotation for the carrier phase compensation and the signals subjected to the rotation reverse to the phase rotation for the carrier phase compensation, and outputting the added signals; and
updating the phase rotation for the carrier phase compensation and the complex impulse response that is multiplied by the adaptive equalizer, by use of an output of the adaptive equalizer.
